(19) United States
(12) Patent Application Publication
(10) Pub. No.: US 2026/0222007 A1
(43) Pub. Date: Jul. 30, 2026

(54) SYSTEMS AND METHODS FOR SIGNAL-TO-NOISE RATIO (SNR) MARGIN ESTIMATION FOR CABLE MODEMS USING MACHINE LEARNING MODELS

(71) Applicant: Avago Technologies International Sales Pte. Limited, Singapore (SG)

(72) Inventors: Gordon Yong Li, San Diego, CA (US); Thomas Kolze, Phoenix, AZ (US); Hong Liu, Irvine, CA (US); Roger Fish, Superior, CO (US); Sean Dunlap, Peachtree Corners, GA (US); Hau Tran, Irvine, CA (US); Kelly Cameron, Irvine, CA (US); Tak Kwan Lee, IRVINE, CA (US)

(73) Assignee: Avago Technologies International Sales Pte. Limited, Singapore (SG)

(21) Appl. No.: 19/040,279

(22) Filed: Jan. 29, 2025

(51) Int. Cl. H04B 3/46; H04L 41/16

(52) U.S. Cl. CPC H04B 3/46; H04L 41/16

(57) ABSTRACT

In some implementations, a system for identifying signal-to-noise ratio (SNR) margins of a cable modem using a trained neural network, may include one or more processors configured to execute the trained neural network to output an SNR margin of the cable modem by inputting to the neural network at least one of a first set of statistical values relating to receive modulation error ratio (RxMER) values corresponding to a plurality of subcarriers of the cable modem, a second set of second statistical values relating to a plurality of iteration numbers, each indicating a number of iterations executed by a decoder to decode a codeword, a third set of values representing power corresponding to a plurality of frequency segments of the cable modem, or a fourth set of values representing a bit loading of the plurality of subcarriers of the cable modem.

### CROSS-REFERENCE TO RELATED APPLICATIONS

This application claims the benefit of and priority to U.S. Provisional Patent Application No. 63/691,619 filed on Sep. 6, 2024, which is incorporated herein by reference in its entirety for all purposes. U.S. patent application Ser. No. 19/039,983 filed on Jan. 29, 2025 is incorporated herein by reference in its entirety for all purposes.

### FIELD OF THE DISCLOSURE

This disclosure generally relates to systems and methods for improving modulation/demodulation process of a communications system, including but not limited to systems and methods of estimating SNR margins of communication links at cable modems using machine learning models.

### BACKGROUND

Cable operators have long held valuable the ability to estimate a signal-to-noise ratio (SNR) margin of downstream digital communications links at a cable modem (e.g., each cable modem in a plant or cable networks). The SNR margin in a cable modem refers to the difference between an actual SNR and a minimum SNR required to maintain a reliable connection, or any measure of the quality of the signal received by the cable modem. Specifically, cable operators have expressed the high value of the SNR margin estimation capability developed for a cable television system defined by a standard like ITU-T J.83B. ITU-T J.83B also defines a standard for downstream cable transmission with single-carrier quadrature amplitude modulation (SC-QAM) with constellation sizes of 64-QAM and 256-QAM, and Forward Error Correction (FEC) which is a concatenated coding scheme. For example, upon installations or repairs of a cable modem (for customers), with a ITU-T J.83B-compatible SNR margin estimation tool, technicians can obtain an SNR margin estimate for the downstream link, and check if the cable modem achieves 3 dB or more of margin using the estimation tool (to check if the cable modem has been successfully installed or repaired).

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a diagram depicting an example communication environment with a plurality of cable modems, a cable modem termination system (CMTS), and a server, according to one or more embodiments.

FIG. 2 is a schematic block diagram of a computing system, according to one or more embodiments.

FIG. 3A and FIG. 3B are diagrams depicting an example process for estimating signal-to-noise ratio (SNR) margins, according to one or more embodiments.

FIG. 4A and FIG. 4B are diagrams depicting an example process for training and/or optimizing one or more machine learning models, according to one or more embodiments.

FIG. 5 is a diagram depicting an example communication environment with a cable modem, a server, and a machine learning engine for estimating SNR margins, according to one or more embodiments.

FIG. 6 is a diagram depicting another example of a communication environment with a cable modem, a server, and a local machine learning engine for estimating SNR margins, according to one or more embodiments.

FIG. 7A and FIG. 7B are diagrams depicting an example machine learning engine, according to one or more embodiments.

FIG. 8 is a flow diagram showing a process for training one or more neural networks for identifying SNR margins of a cable modem, in accordance with an embodiment.

FIG. 9 is a flow diagram showing a process for identifying SNR margins of a cable modem using a trained neural network, in accordance with an embodiment.

The details of various embodiments of the methods and systems are set forth in the accompanying drawings and the description below.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, a first feature in communication with or communicatively coupled to a second feature in the description that follows may include embodiments in which the first feature is in direct communication with or directly coupled to the second feature and may also include embodiments in which additional features may intervene between the first and second features, such that the first feature is in indirect communication with or indirectly coupled to the second feature. In addition, the present disclosure may repeat reference numerals and/or letters in the various examples. This repetition is for the purpose of simplicity and clarity and does not in itself dictate a relationship between the various embodiments and/or configurations discussed.

The term “cable modem” refers to a device that can function as a bridge between a local network and an internet service provider (ISP) using the same coaxial cable infrastructure that delivers cable television, a device that can convert (e.g., demodulate) data signals received from an ISP using the coaxial cable infrastructure into a format that devices in a local network (e.g., local area network (LAN)) can use, and convert (e.g., modulate) data signals from the LAN into an analog signal that can be transmitted to the ISP using the coaxial cable infrastructure, or any device that can connect a local network to the Internet using the same coaxial cable infrastructure.

The term “SNR margin” in computer systems and/or networking systems (e.g., a cable modem) refers to the difference between an actual SNR and a minimum SNR required to maintain a reliable connection, or any measure of the quality of the signal received by the cable modem. The term “subcarrier” in a computer and/or networking system refers to a narrowband frequency channel used in Orthogonal Frequency Division Multiplexing (OFDM) systems.

The term “training set” or “training data set” in machine learning refers to a collection of data used to train a model for teaching an algorithm to recognize patterns and make predictions, for example.

The term “receive modulation error ratio (RxMER)” in computer systems and/or communication systems (e.g., a cable modem) refers to a ratio between average signal power of a received signal and average noise power of the signal, or a ratio between power of the received signal to power of errors in the signal. An RxMER value can indicate how well a signal is being received such that higher RxMER values indicate better signal quality.

The term “input power” in computer systems and/or communication systems (e.g., a cable modem) refers to electrical power supplied to a system's components to ensure their proper functioning, or an amount of energy received by the system's components. The term “output power” in computer systems and/or communication systems (e.g., a cable modem) refers to electrical power output by a system's components or an amount of power delivered by a system's component or a device to its load or to any other component or device.

The term “channel” in computer systems and/or communication systems (e.g., a cable modem) refers to a physical medium, such as a wire or fiber optic cable, a logical connection over a multiplexed medium, a frequency channel in wired or wireless communications, a specific frequency band or range of frequencies used for transmitting and receiving data, or any communication link between two devices or systems that allows data to be transmitted and received.

The term “bit loading” refers to a process of dynamically or statically assigning a respective number of bits (e.g., constellation size) to each subcarrier in a channel (e.g., an OFDM channel) based on channel conditions, or a number of bits assigned to a subcarrier as a result of the bit loading process.

The term “decoder” in computer systems and/or communication systems (e.g., a cable modem) refers to a component that takes an encoded or compressed signal and converts it back to its original format or representation. Decoders are used to retrieve and interpret data that has been encoded or compressed for efficient transmission over wired or wireless channels.

The term “codeword” in error correction code (ECC) systems refers to a sequence of bits that includes both the original data and additional redundant bits. These redundant bits are added to help detect and correct errors that may occur during data transmission over unreliable or noisy communication channels.

The term “uncorrectable errors” in an ECC system refers to errors that the system detects but cannot correct. These errors occur when the number of errors in the received data exceeds the correction capability of the error correction code being used. The term “correctable errors” in an ECC system refers to errors that the system can detect and correct using the redundant information added during the encoding process. These errors occur within the correction capability of the ECC being used. The term “error rate” in an ECC system refers to a symbol error rate (SER), a bit error rate (BER), a frame error rate (FER), or any metric which measures the probability of errors occurring in transmitted or stored data.

The term “amplifiers” in computer systems and/or communication systems (e.g., a cable modem) refers to voltage amplifiers, current amplifiers, power amplifiers, transconductance amplifiers, trans-resistance amplifiers, operational amplifiers (Op-Amps), audio amplifiers, or any circuit or device that boost the power level of signals to ensure the signals can be transmitted over long distances or through various media without significant loss or degradation.

The term “cable modem termination system (CMTS)” refers to a system, device or equipment that is used by cable internet service providers to manage and facilitate communication between cable modems and the internet, is located in a cable company's headend or hubsite to provide data services such as cable internet or Voice over IP (VoIP) to cable subscribers, and/or enables communication with subscribers'cable modems.

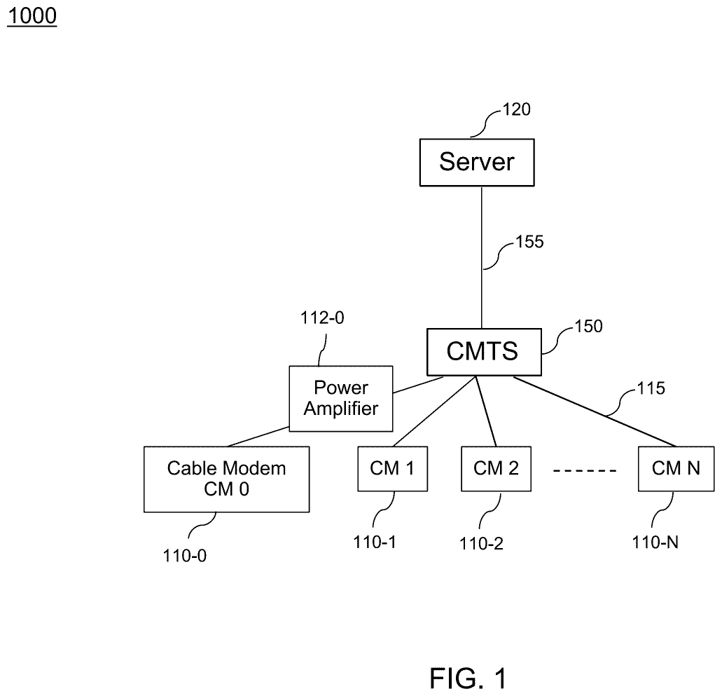

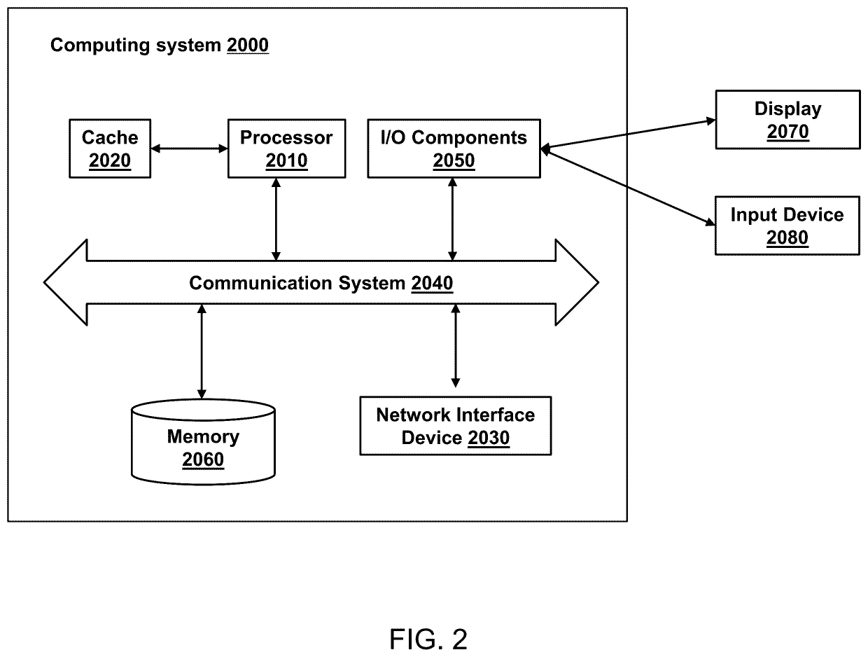

FIG. 1 is a diagram depicting an example communication environment 1000 with a plurality of cable modems 110-0, 110-1, . . . , 110-N, a cable modem termination system (CMTS) 150, and a server 120, according to one or more embodiments. Each cable modem 110-0, 110-1, . . . , 110-N can include one or more ports for the coaxial cable from an ISP, an Ethernet port to connect to a router or a computer in a local network, and/or additional ports for telephony services. Each cable modem 110-0, 110-1, . . . , 110-N can have configuration similar to configuration of a computing system 2000 in FIG. 2. The server 120 can have configuration similar to configuration of a computing system 2000 in FIG. 2. The server 120 may include a computing device (e.g., computing system 2000) and/or a cloud system. The cloud system refers to a system that can deliver one or more services over the Internet. The one or more services can include one or more services of infrastructure as a service (IaaS), platform as a service (PaaS), or software as a service (SaaS). Each cable modem can transmit or receive data (e.g., telemetry data) to the server 120. For example, each cable modem can automatically collect and transmit data to the server for monitoring and analysis. The CMTS 120 can connect between the server 120 and the plurality of cable modems 110-0, 110-1, . . . , 110-N to provide data services such as cable internet or VoIP to cable subscribers. The CMTS 120 can connect to the server 120 via a computer network 155 (e.g., Internet) and connect to the cable modems via coaxial cables 115. In some implementations, one or more power amplifiers (e.g., power amplifier 112-0) can be connected between the CMTS 150 and a cable modem 110-0 to boost the signal strength of a signal traveling between the CMTS and the cable modem to ensure that the signal can travel long distances without significant loss or degradation.

FIG. 2 is a schematic block diagram of a computing system, according to an embodiment. An illustrated example computing system 2000 includes one or more processors 2010 in direct or indirect communication, via a communication system 2040 (e.g., bus), with memory 2060, at least one network interface controller 2030 with network interface port for connection to a network (not shown), and other components, e.g., input/output (“I/O”) components 2050. Generally, the processor(s) 2010 will execute instructions (or computer programs) received from memory. The processor(s) 2010 illustrated incorporate, or are connected to, cache memory 2020. In some instances, instructions are read from memory 2060 into cache memory 2020 and executed by the processor(s) 2010 from cache memory 2020. The computing system 2000 may not necessarily contain all of these components shown in FIG. 2 and may contain other components that are not shown in FIG. 2.

In more detail, the processor(s) 2010 may be any logic circuitry that processes instructions, e.g., instructions fetched from the memory 2060 or cache 2020. In many implementations, the processor(s) 2010 are microprocessor units or special purpose processors. The computing device 2050 may be based on any processor, or set of processors, capable of operating as described herein. The processor(s) 2010 may be single core or multi-core processor(s). The processor(s) 2010 may be multiple distinct processors.

The memory 2060 may be any device suitable for storing computer readable data. The memory 2060 may be a device with fixed storage or a device for reading removable storage media. Examples include all forms of volatile memory (e.g., RAM), non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 2000 may have any number of memory devices 2060.

The cache memory 2020 is generally a form of computer memory placed in close proximity to the processor(s) 2010 for fast read times. In some implementations, the cache memory 2020 is part of, or on the same chip as, the processor(s) 2010. In some implementations, there are multiple levels of cache 2020, e.g., L2 and L3 cache layers.

The network interface controller 2030 manages data exchanges via the network interface (sometimes referred to as network interface ports). The network interface controller 2030 handles the physical and data link layers of the OSI model for network communication. In some implementations, some of the network interface controller's tasks are handled by one or more of the processor(s) 2010. In some implementations, the network interface controller 2030 is part of a processor 2010. In some implementations, the computing system 2000 has multiple network interfaces controlled by a single controller 2030. In some implementations, the computing system 2000 has multiple network interface controllers 2030. In some implementations, each network interface is a connection point for a physical network link (e.g., a cat-5 Ethernet link). In some implementations, the network interface controller 2030 supports wireless network connections and an interface port is a wireless (e.g., radio) receiver or transmitter (e.g., for any of the IEEE 802.11 protocols, near field communication “NFC”, Bluetooth, ANT, or any other wireless protocol). In some implementations, the network interface controller 2030 implements one or more network protocols such as Ethernet. Generally, a computing device 2050 exchanges data with other computing devices via physical or wireless links through a network interface. The network interface may link directly to another device or to another device via an intermediary device, e.g., a network device such as a hub, a bridge, a switch, or a router, connecting the computing device 2000 to a data network such as the Internet.

The computing system 2000 may include, or provide interfaces for, one or more input or output (“I/O”) devices. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

Other components may include an I/O interface, external serial device ports, and any additional co-processors. For example, a computing system 2000 may include an interface (e.g., a universal serial bus (USB) interface) for connecting input devices, output devices, or additional memory devices (e.g., portable flash drive or external media drive). In some implementations, a computing device 2000 includes an additional device such as a co-processor, e.g., a math co-processor can assist the processor 2010 with high precision or complex calculations.

The components 2090 may be configured to connect with external media, a display 2070, an input device 2080 or any other components in the computing system 2000, or combinations thereof. The display 2070 may be a liquid crystal display (LCD), an organic light emitting diode (OLED) display, a flat panel display, a solid state display, a cathode ray tube (CRT) display, a projector, a printer or other now known or later developed display device for outputting determined information. The display 2070 may act as an interface for the user to see the functioning of the processor(s) 2010, or specifically as an interface with the software stored in the memory 2060.

The input device 2080 may be configured to allow a user to interact with any of the components of the computing system 2000. The input device 2080 may be a plurality pad, a keyboard, a cursor control device, such as a mouse, or a joystick. Also, the input device 2080 may be a remote control, touchscreen display (which may be a combination of the display 2070 and the input device 2080), or any other device operative to interact with the computing system 2000, such as any device operative to act as an interface between a user and the computing system 2000.

In one aspect, cable operators have long held valuable the ability to estimate a signal-to-noise ratio (SNR) margin of downstream digital communications links at a cable modem (e.g., each cable modem in a plant or cable networks). Specifically, cable operators have expressed the high value of the SNR margin estimation capability developed for a cable television system defined by a standard like ITU-T J.83B. ITU-T J.83B which also defines a standard for downstream cable transmission with single-carrier quadrature amplitude modulation (SC-QAM) with constellation sizes of 64-QAM and 256-QAM, and Forward Error Correction (FEC) which is a concatenated coding scheme. For example, upon installations or repairs of a cable modem (for customers), with a ITU-T J.83B-compatible SNR margin estimation tool, technicians can obtain an SNR margin estimate for the downstream link, and check if the cable modem achieves 3 dB or more of margin using the estimation tool (to check if the cable modem has been successfully installed or repaired).

In one aspect, a conventional SNR margin estimation approach may operate by counting bit error corrections which occur in an outer decoder, which forms a good approximation of the bit error rate at the input to the outer decoder and thus, a good approximation of the bit error rate at the output after decoding with an inner decoder. It has been shown, and used in practice, that counting the bit error corrections in the outer decoder, when operating at lower bit error rates than FEC threshold, can be effective for accurate estimation of link margin for up to 3 dB of margin and more (for example, in additive white Gaussian noise (AWGN)). However, for the conventional SNR margin estimation tool to operate for a single carrier (SC)-QAM constellation (64-QAM or 256-QAM), the downstream link has to be operating (e.g., carrying traffic) with that constellation.

Moreover, with the roll-out of data over cable service interface specifications (DOCSIS) 3.1 and OFDM and new FEC thereof, the conventional SNR margin estimation was no longer available with the new FEC. With DOCSIS OFDM, many variations of bit loading (e.g., mixes of constellation size among the data carrying subcarriers) are possible. For example, with DOCSIS OFDM, cable modems support four different profiles (or bit profiles), and another profile for test purposes. Here, the “profile” (also referred to as “bit profile” or “bit loading profile”) refers to a specific configuration (e.g., number of bits that can carry traffic, modulation orders, constellation density, constellation size, etc.) for each subcarrier within an OFDM. The conventional SNR margin estimation may provide an under-estimate of the FEC threshold, which is hugely unattractive (damaging) if operated (practiced) in a cable system. The conventional SNR margin estimation will likely lead to a too aggressive bit loading profile, and eventually a failure of that profile (for example, high codeword error rate would make the profile unusable).

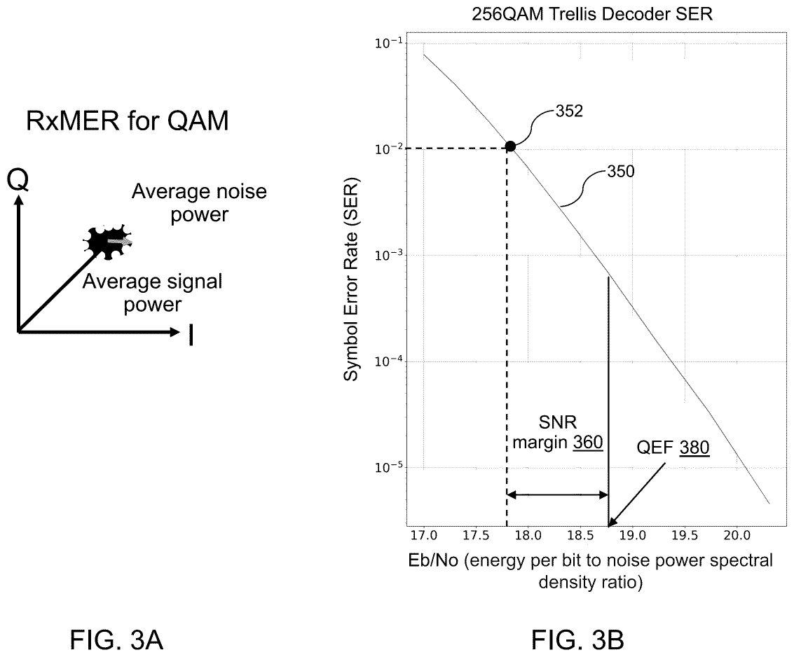

FIG. 3A and FIG. 3B are diagrams depicting an example process for estimating signal-to-noise ratio (SNR) margins, according to one or more embodiments. In a communication environment with one or more cable modems (see FIG. 1), a channel quality (e.g., quality of signals in a channel in OFDM) can be characterized by a receive modulation error ratio (RxMER) value. FIG. 3A shows calculating an RxMER value when using a quadrature amplitude modulation (QAM) which can combine two amplitude-modulated signals into one by using I/Q modulation.

FIG. 3B shows how a cable modem (e.g., a system compatible with DOCSIS 3.0) can perform an SNR margin estimation. For example, the system can use a Trellis decoder with 256 QAM. The system can measure the current symbol error rate (SER) 352 which follows a curve 350 (e.g., waterfall curve). This waterfall curve can be obtained by the inner Trellis decoder. Using the curve 350, the system can identify, as the SNR margin 360, a distance to the SER 352 from the Quasi-Error-Free (QEF) point 380 (e.g., bit error rate (BER)=1e−8 at Reed-Solomon decoder output) on the x axis (e.g., an axis representing Eb/No). The same measuring process can be applicable to a bit error rate (BER) curve. For example, the system can measure an SNR margin using the BER curve in the same manner.

In one aspect, DOCSIS 3.0 supports a narrow band single carrier (6 MHz per channel) and a constant QAM modulation per channel, while DOCSIS 3.1 supports a wide band channel with multiple subcarriers per channel (e.g., OFDM) and non-constant modulations across subcarriers. In performing the SNR margin estimation shown in FIG. 3B, in response to identifying or obtaining the SNR margin, the cable modem can transmit the measured SNR margin to a remote server (e.g., server 120 in FIG. 1). A similar SNR margin estimation approach is not available in DOCSIS 3.1-compliant systems for OFDM, because the inner decoder in the concatenated coding has an extremely steep slope for the error rate versus SNR and cannot provide the margin estimate reliably as in DOCSIS 3.0-compliant systems. It is advantageous for the cable modem to perform the SNR margin estimation as opposed to sending all the information back to a server each time the SNR margin estimate is desired, because significantly more modulation schemes (many different constellation densities used across the subcarriers of an OFDM channel, potentially) are used for each downstream OFDM channel, than the single carrier QAM channel in DOCSIS 3.0-compliant systems. As a result, the cable modem may need to transmit significantly more measured SNR data (RxMER per subcarrier) to the remote server, compared with the DOCSIS 3.0-compliant system. That is, if the SNR margin estimation shown in FIG. 3B is applied to a DOCSIS 3.1-compliant system, and not performed in the cable modem, significant bandwidth consumption would be incurred due to periodic RxMER polling of all devices and because the polling method of the server provides a limited control, significant overhead (e.g., increased polling rates) would be required to detect transient impairments. For example, such FEC error rate-based approach (e.g., the SNR margin estimation shown in FIG. 3B) is inaccurate with non-AWGN channel impairments. Moreover, the SNR margin estimation shown in FIG. 3B is based on measurement (e.g., measurement of SER or BER), it cannot operate on inactive profiles, e.g., profiles are not currently operating during the measurement period (do not currently carry data). In DOCSIS 3.1-compliant systems, there are multiple possible bit profiles commanded to each cable modem, and the SNR margin estimate is (in general) desired on each such profile, whether active or inactive. The SNR margin estimation approach for DOCSIS 3.0-compliant systems can only perform on the active modulation in a downstream channel.

In one aspect, SNR margins can be estimated using a closed-form formula or a fixed table. It is preferable that such a formula or a fixed table can be applicable to many different conditions (e.g., different channel conditions in different subcarriers). For example, a subcarrier with a low SNR may affect the performance of the whole channel. However, it would be difficult to design and/or develop a closed-form formula that can characterize a very complex relationship between such different conditions and SNR margins. Similarly, it would be difficult to build a fixed table that can characterize a very complex relationship between such different conditions and SNR margins. Moreover, as massive data (e.g., data relating to communication performance of cable modems) can be collected from a cable modem system (see FIG. 1), it would be difficult to use or process the massive data to ensure that such a closed-form formula or a fixed table fits with the massive data.

To solve these problems, systems and methods according to some embodiments of the present disclosure can use or leverage machine learning capability to augment analysis in estimating SNR margins. In some implementations, a system (e.g., a server 120, a CMTS 150, a cable modem 110-0, or a combination thereof) can rebuild a fixed mapping using artificial intelligence (AI) and/or machine learning (ML) which can be effective to characterize very complex relationship between input data and output data. In some implementations, the system can collect massive data (e.g., data relating to communication performance of cable modems) and use the massive data in estimating SNR margins. In some implementations, the system can perform cable modem-based SNR margin estimation for inactive profiles with DOCSIS OFDM.

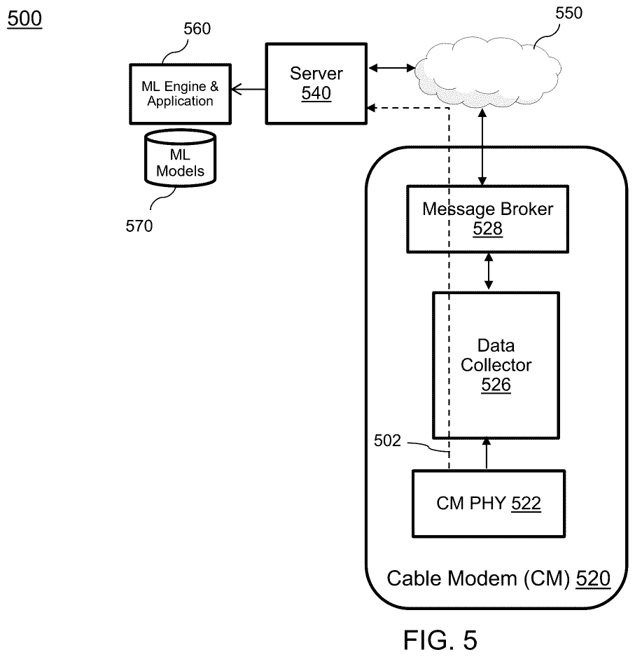

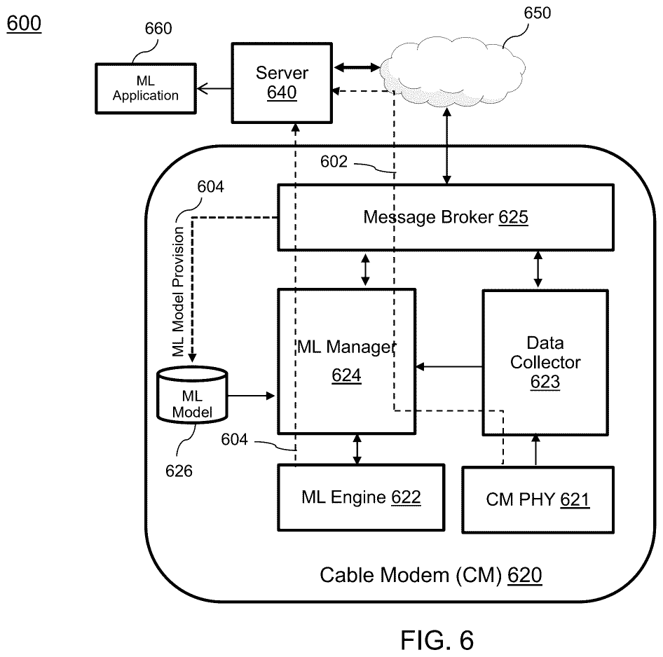

In some implementations, the system can collect one or more datasets. The datasets can include one or more input datasets (or test datasets) and/or one or more label datasets (e.g., datasets including ground truth). In some implementations, the datasets can be collected in a laboratory testing environment with appropriate labeling, or generated by performing simulations (e.g., executing simulators). In some implementations, the datasets can be collected from or by the system (e.g., a server 120, a CMTS 150, a cable modem 110-0, or a combination thereof) while the system is in operation. In some implementations, the system can create one or more machine learning models and/or select one or more machine learning models from among a plurality of machine learning models. In some implementations, the system can train and/or optimize one or more machine learning models using the one or more input datasets (or test datasets) and/or the one or more label datasets. In some implementations, the system can store one or more trained machine learning models in a storage (e.g., storage similar to the memory 2060). In some implementations, the one or more trained machine learning models can be precompiled binary codes (e.g., codes executable by one or more processors 2010) or framework files (e.g., a configuration file based on which a trained machine learning model can be executed). In some implementations, the system can perform an iterative process of creating, training, and/or optimizing a machine learning model. In some implementations, the system can characterize performance and/or complexity of each machine learning model, and/or deploy a (trained) machine learning model per machine learning application deployment options. In general, there can be three deployment options: a) deploy and execute the machine learning models in cloud or server, as illustrated in FIG. 5; b) deploy and execute the machine learning models on cable models, as illustrated in FIG. 6; or c) deploy and execute the machine learning models jointly in cloud and on cable models.

The various illustrative logical blocks, modules, circuits, and algorithm blocks described in connection with the examples disclosed herein may be implemented or performed using one or more various machine learning models. By way of example, such machine learning models can comprise supervised learning models, clustering models, neural network models, reinforcement learning models, decision trees, support-vector machines, Bayesian networks, Gaussian processes, genetic algorithms models, any other models that can be used by one or more machine learning algorithms, any other models that can learn from data (e.g., training data) to perform tasks without explicit instructions, or various combinations thereof. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), any other models that can learn patterns and make predictions or decisions, or various combinations thereof.

By way of example but not limitation, a neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs.

The machine learning models may be implemented by concatenating or combining a plurality of machine learning models. By way of example but not limitation, one model of the plurality of machine learning models can drive a subsequent model. The plurality of machine learning models can be implemented using a pipeline or chaining approach, where the output of one model serves as the input for another. For example, the plurality of machine learning models can use a pipeline or a pipeline class to implement chain models for learnings and preprocessing (e.g., data transformation, normalization and feature extraction). The plurality of machine learning models can use chaining in deep learning by feeding one model's output into another model. By way of example but not limitation, each model of the plurality of machine learning models can perform a part of the overall processing such that different models can handle different parts of input data and combine their outputs. This method allows for creating complex workflows where each model or step contributes to the overall processing.

The machine learning models can be configured, learned or trained using various learning or training operations, such as unsupervised learning, weakly supervised learning, semi-supervised learning, supervised learning, any other learning or training operations that can learn from data (e.g., training data) and generalize to unseen data, or various combinations thereof. For example, parameters of nodes of a neural network model such as weights, biases, and/or thresholds can be configured, learned or trained using various learning or training operations, such as unsupervised learning, weakly supervised learning, semi-supervised learning, or supervised learning. A machine learning model can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations). The training data can include human-labeled information, including but not limited to feedback regarding outputs of the machine learning model, which can allow the machine learning model to generate more human-like outputs.

The machine learning models may be implemented in hardware, software, firmware, or any combination thereof. Hardware implementations of machine learning models can be designed to accelerate and optimize machine learning models. By way of example but not limitation, the machine learning models may be implemented in microprocessor units, special purpose processors such as graphics processing units (GPUs), field-programmable gate arrays (FPGAs), application-specific integrated circuits (ASICs), neuromorphic hardware or neuromorphic chips, or any logic circuitry that processes instructions. The hardware implementations of machine learning models can accelerate and/or optimize training and inference in machine learning using their parallel processing capabilities, customizable hardware acceleration (e.g., customization using FPGA or ASCs). The hardware implementations of machine learning models can mimic the architecture of the human brain to perform computations more efficiently (e.g., neuromorphic hardware). The hardware implementations of machine learning models can enable real-time processing on various devices like drones, robots, internet of thing (IoT) devices, or any embedded systems. The hardware implementations of machine learning models can be reconfigurable (e.g., using FPGAs or ASICs), allowing for dynamic adaptation to different machine learning models and/or machine learning workloads.

In some implementations, the system can use a neural network model (e.g., a fully connected (FC) neural network model or a CNN-based model) in estimating SNR margins. In some implementations, the neural network model can include an input layer, a plurality of hidden layers (e.g., a first hidden layer, a second hidden layer, etc.), and an output layer. In some implementations, the system can configure the number of layers and/or the number of nodes in each layer in the neural network model. In some implementations, the system can use an input tensor (e.g., a multi-dimensional array of numbers that can represent complex data relationships) to represent data input to the neural network model. For example, an input tensor can include m-dimensional data X₁, X₂, . . . , Xₘ. In some implementations, the neural network model can receive the input tensor as input to the input layer and output data from the output layer. In some implementations, in estimating an SNR margin, the system can use an array of SNR margin bins to represent data output from the neural network model. In some implementations, the data output from the neural network model can represent a probability distribution over multiple classes using a softmax activation function. For example, the data output from the neural network model can include three softmax activation output values (probabilities) y⁽³⁾₁, y⁽³⁾₂, and y⁽³⁾₃ of index values of corresponding SNR margin bins (e.g., first, second and third SNR margin bins). In some implementations, the system can use an API for building and training neural network models (e.g., Keras/Python environment on computers). In some implementations, the system can output or store trained neural network models as files compatible with an open-source platform for machine learning (e.g., TensorFlow files).

In some implementations, a system can deploy one or more machine learning (ML) models for SNR margin estimation in a remote server or a cloud system (e.g., cloud deployment option). In some implementations, the system can include an ML storage, an ML engine and application, a server, and/or a cable modem. In some implementations, the ML storage can have configurations similar to the memory 2060 in FIG. 2. In some implementations, the ML storage can store one or more ML models (e.g., neural network models). In some implementations, the ML engine and application can be implemented in hardware, software, firmware, or any combination thereof. In some implementations, the ML engine and application can have configurations similar to configurations of the computing system 2000 in FIG. 2. In some implementations, the ML engine and application can create, train and/or optimize one or more ML models. In some implementations, the ML engine and application can execute one or more ML applications. For example, the one or more ML applications can include estimation of SNR margins and/or a performance dashboard (e.g., processing results or output of a (trained) ML model and rendering the processed results on the performance dashboard to show performance of one or more cable modems). In some implementations, the server can have configurations similar to configurations of the server 120 in FIG. 1. In some implementations, the ML engine and application can be implemented in the server. In some implementations, the server can function as a portal or an entry point to various cable modem-related services (e.g., monitoring performance of cable modems). On behalf of applications (such as ML applications), the portal can access cable modems to collect analytics data and provide control and configuration information. Furthermore, the portal can process and render the application information (for example in a dashboard).

In some implementations, the cable modem can have configurations similar to the cable modem 110-0 in FIG. 1. In some implementations, the cable modem can include a message broker, a data collector, and/or a cable modem (CM) physical layer (PHY). In some implementations, each of the message broker, the data collector, and the CM PHY can be implemented in hardware, software, firmware, or any combination thereof. In some implementations, the CM PHY can obtain or measure values relating to performance of the cable modem, such as RxMER values, a number of iterations performed in a FEC decoder, input power in a frequency segment across a channel (e.g., DOCSIS downstream channel), modulation configuration (e.g., OFDM bit-loading profile), an error rate of FEC correctable errors, and/or an error rate of FEC uncorrectable errors, etc. In some implementations, the data collector can collect data relating to performance of the cable modem, from the CM PHY or other components, and send the collected data to the message broker. In some implementations, the message broker can manage communication with the server and/or with the ML engine and application via a computer network. For example, in response to receiving the collected data from the data collector, the message broker can send, communicate, or transmit the collected data to the server and/or the ML engine and application so that the ML engine can use the collected data to train and/or optimize the one or more ML models. In some implementations, the ML engine can use the collected data for inference using a trained ML model. For example, the ML engine can provide the collected data as input to the trained ML model so that the ML model can output an inference result (e.g., estimated SNR margin). In this configuration, the system can utilize cloud ML processing assets (e.g., ML engine and application in a cloud system) thereby the ML models can run without significant impact on the rest of cable modem (CM) functions.

In some implementations, a system can deploy one or more machine learning (ML) models for SNR margin estimation in a cable modem (e.g., local deployment option). In some implementations, the system can include an ML application, a server, and/or a cable modem. In some implementations, each of the ML application, the server and the cable modem can have configurations similar to configurations of the computing system 2000 in FIG. 2. In some implementations, the ML application can be implemented in the server. In some implementations, the server can have configurations similar to configurations of the server 120 in FIG. 1. In some implementations, the server can function as a portal or an entry point to various cable modem-related services (e.g., monitoring performance of cable modems). In some implementations, the ML application can execute one or more ML applications. For example, the one or more ML applications can include estimation of SNR margins and/or a performance dashboard (e.g., processing results or output of a (trained) ML model and rendering the processed results on the performance dashboard to show performance of one or more cable modems).

In some implementations, the cable modem can have configurations similar to the cable modem 110-0 in FIG. 1. In some implementations, the cable modem can include an ML storage, an ML engine, an ML manager, a message broker, a data collector, and/or a CM PHY. In some implementations, each of the ML engine, the ML manager, the message broker, the data collector, and the CM PHY can be implemented in hardware, software, firmware, or any combination thereof. In some implementations, the ML storage can have configurations similar to the memory 2060 in FIG. 2. In some implementations, the ML storage can store one or more ML models (e.g., neural network models). In some implementations, the ML engine can create, train and/or optimize one or more ML models. In some implementations, the message broker can receive one or more ML models from the server or the ML application, and store the received one or more ML models in the ML storage (e.g., ML model provision). In some implementations, the cable modem can receive one or more ML models from the server or the ML application without going through the message broker (e.g., the ML models can be pre-installed in the cable modems).

In some implementations, the CM PHY can obtain or measure values relating to performance of the cable modem, such as RxMER values, a number of iterations performed in a FEC decoder, input power in a frequency segment across a channel (e.g., DOCSIS downstream channel), modulation configuration (e.g., OFDM bit-loading profile), an error rate of FEC correctable errors, and/or an error rate of FEC uncorrectable errors, etc. In some implementations, the data collector can collect data relating to performance of the cable modem, from the CM PHY or other components, and send the collected data to the message broker or to the ML manager.

In some implementations, the ML manager can control the ML engine to train and/or optimize one or more ML models using the collected data from the data collector. In some implementations, the ML manager can control the ML engine to use the collected data for inference using a trained ML model. For example, the ML engine can provide the collected data as input to the trained ML model so that the ML model can output an inference result (e.g., estimated SNR margin). In response to the ML model outputting the inference result, the ML manager can send the inference result to the message broker.

In some implementations, the message broker can manage communication with the server and/or with the ML application via a computer network. For example, in response to receiving the collected data from the data collector or receiving the inference result from the ML manager, the message broker can send, communicate, or transmit the collected data or the inference result to the server and/or the ML application so that the ML application can process the collected data or the inference result. For example, the ML application can render the processed result on a performance dashboard to show performance of the cable modem. In some implementations, the system can utilize local ML processing assets (e.g., on-chip ML processing of the cable modem including the ML engine). In some implementations, the system can utilize general computational power of the cable modem (e.g., CPU or GPU of the cable modem) for ML processing if the ML model can run without significant impact on the rest of the CM function.

In some implementations, an ML engine can retrain (or refine) one or more pre-trained neural network (NN) models including a first NN model for inference of SNR margins of a particular cable modem, a second NN model for inference of uncorrectable FEC errors of the cable modem, and/or a third NN model for inference of correctable FEC errors of the cable modem. In some implementations, the ML engine can retrain (or refine) other types of pre-trained ML models (other than NN models) for inference of SNR margins of a particular cable modem, uncorrectable FEC errors of the cable modem, and/or correctable FEC errors of the cable modem. In some implementations, the ML engine can retrain (or refine) the pre-trained NN models (e.g., the first NN model, the second NN model, the third NN model) using respective training datasets, each training dataset including input datasets and/or label datasets (e.g., ground truth data). In some implementations, the training datasets (e.g., both input datasets and label datasets) can be collected in a laboratory testing environment with appropriate labeling, or generated by performing simulations (e.g., executing simulators). In some implementations, input datasets can be collected using a data collector of a cable modem, and label datasets can be generated in a laboratory testing environment and/or by executing simulators. In some implementations, the ML engine can train an NN model by iteratively (1) inputting one or more input datasets to the NN model to output data, (2) calculating a loss based on the output data of the NN model and the label data, and (3) updating the NN model based on the loss. In some implementations, during training, the output data being inferred can be provided to the NN model in addition to the datasets (e.g., the input dataset and the label dataset).

In some implementations, the ML engine can train the first NN model using (training) input datasets including at least one of datasets of (1) statistical values of RxMER (e.g., cumulative distribution function (CDF), average (AVG), standard deviation (STD), etc.), (2) statistical values of the number of iterations performed by a FEC decoder (e.g., CDF, AVG, STD, etc.), (3) a distribution of input power within one or more frequency segment across a channel of the cable modem, (4) an OFDM bit-loading profile, (5) an error rate of uncorrectable FEC errors, (6) an error rate of correctable FEC errors, (7) a channel condition (e.g., SNR profile category), and/or (8) output power of a power amplifier. In some implementations, the ML engine can train the first NN model using label datasets including at least one of datasets of (1) SNR margin (equivalently referred to as “SNR threshold”) and/or (2) recommended bit loading (to improve communication performance of a cable modem). In some implementations, the ML engine can optimize the recommended bit loading for a given node (e.g., cable modem).

In some implementations, the input dataset (1) of statistical values of RxMER can include an array of RxMER values (e.g., in float32 number format which is a 32-bit a single-precision floating-point number format) including N percentage bins representing RxMER CDF. For example, the array of float32 numbers can have a size of 24 (e.g., float32 [0 :23]) corresponding to respective percentage bins of 1, 2, 3, 4, 5, 10, 15, 20, 25, 30, 40, 50, 60, 70, 80, 90, 95, 98, 99, 99.9%, a minimum RxMER value, a maximum RxMER value, an AVG RxMER value, and a STD RxMER value. In some implementations, the RxMER CDF can represent a CDF of RxMER values for each bit-loading value, when non-uniform bit-loading is applied. In some implementations, the input datasets can include a CDF of symbol error rate (SER) values and/or a CDF of bit error rate (BER) values, for each bit-loading. In some implementations, the input datasets can include different RxMER CDFs for each bit loading, for cases with non-uniform bit loading on subcarriers.

In some implementations, the input dataset (2) of statistical values of the number of iterations can include an array of a plurality of percentage bins representing a CDF of FEC decoder iterations. For example, the array can include a plurality of elements representing percentage bins each corresponding to a percentage of codewords that require n (e.g., n=1,2,3, . . . , 12, 30) or more iterations. The array can also include an AVG iteration value.

In some implementations, the input dataset (3) of a distribution of input power of a cable modem can include an array of input power within 6 MHz frequency segments across DOCSIS downstream channels. For example, the array of float32 numbers can have a size of 32 (e.g., float32 [0:31]), corresponding to the distribution across one 192 MHz OFDM channel. In some implementations, the input dataset (4) of an OFDM bit-loading profile can include an integer value which corresponds to an index of an array of predefined bit-loading profiles.

In some implementations, the input dataset (5) of an error rate of uncorrectable FEC errors can include an integer value corresponding to an index of an array of error rate bins. In some implementations, the input dataset (6) of an error rate of correctable FEC errors can include an integer value corresponding to the index of an array of error rate bins.

In some implementations, the input dataset (7) of a channel condition can represent an SNR profile category as a channel condition known during training. In some implementations, the input dataset (7) of a channel condition can include values corresponding to channel information such as: (1) attenuation of high frequencies; (2) narrowband interference; (3) frequency-selective fading; (3) a level of SNR values (e.g., low, medium, high SNR); and(4) Intersymbol Interference (ISI) and Intercarrier Interference (ICI).

In some implementations, the input dataset (8) of output power of a power amplifier (e.g., power amplifier 112-0 in FIG. 1) can be optionally used in training the first NN model in order to incorporate the effect of a power amplifier with nonlinear artifacts, possibly digital predistortion (DPD), into the estimate of SNR margin (or SNR threshold). Internal testing has reportedly indicated a large shift in relation between an AVG RxMER value and an estimated SNR threshold value occurring at a power amplifier, compared to the interface C downstream modulators (which is a part of the CMTS). For example, a power amplifier with nonlinear artifacts may result in neighborhood of 3 dB higher SNR threshold compared to the interface C downstream modulators (and a simulated theory). With DPD or other nonlinear distortion, the presence of linear distortion may cause further degradation in RxMER, and may possibly alter the relation of RxMER CDF and the SNR threshold. In some implementations, the input dataset (8) of output power of a power amplifier can include a value representing a characterization of the power amplifier (e.g., presence or absence of nonlinear distortion). In some implementations, the input dataset (8) of output power of a power amplifier can include one or more values representing output power of the power amplifier.

In some implementations, the label dataset (1) of SNR margins can include an integer value corresponding to an index of an array of SNR margin bins. In some implementations, the label dataset (2) of recommended bit loading (e.g., a recommended bit loading profile) can include an integer value which corresponds to an index of an array of predefined bit-loading profiles.

In some implementations, the ML engine can train the second NN model using (training) input datasets including at least one of datasets of (1) statistical values of RxMER (e.g., CDF, AVG, STD, etc.), (2) statistical values of the number of iterations performed by a FEC decoder (e.g., CDF, AVG, STD, etc.), (3) a distribution of input power within one or more frequency segment across a channel of the cable modem, and/or (4) an OFDM bit-loading profile. In some implementations, the ML engine can train the second NN model using a label dataset of a rate of uncorrectable FEC errors. In some implementations, the dataset of a rate of uncorrectable FEC errors can include an integer value corresponding to an index of an array of error rate bins for uncorrectable FEC errors.

In some implementations, the ML engine can train the third NN model using (training) input datasets including at least one of datasets of (1) statistical values of RxMER (e.g., CDF, AVG, STD, etc.), (2) statistical values of the number of iterations performed by a FEC decoder (e.g., CDF, AVG, STD, etc.), (3) a distribution of input power within one or more frequency segment across a channel of the cable modem, and/or (4) an OFDM bit-loading profile. In some implementations, the ML engine can train the third NN model using a label dataset of a rate of correctable FEC errors. In some implementations, the dataset of a rate of correctable FEC errors can include an integer value corresponding to an index of an array of error rate bins for correctable FEC errors.

In some implementations, the system (e.g., ML engine) can use the 3 independent NN models for inference of SNR margin, uncorrectable FEC errors, and correctable FEC errors, respectively, thereby providing simpler models, faster training, and modular solutions. In some implementations, the system can use a unified NN model (instead of the 3 independent NN models) for joint inference of all three outputs (SNR margin, uncorrectable FEC errors, and correctable FEC errors). In some implementations, the system can use an additional label dataset (or an additional inference output from a trained NN model) raising a “red flag” for alert of a condition warranting attention. In some implementations, input datasets for training an NN model can be a tensor. In some implementations, the system can use a tensor including all of the input datasets (1)-(6) for training the first NN model (for inference of SNR margins).

In some implementations, for an initial ML model training, the ML engine can fix the input dataset (4) of the OFDM bit-loading profile and the input dataset (7) of SNR profile category, and can limit the input datasets to the input dataset (1) of RxMER CDF, the input dataset (2) of FEC iteration CDF, and (optionally) the input dataset (3) of CM input power distribution. In some implementations, for the initial ML model training, the ML engine can focus on training the first NN model for SNR margin only (no FEC error estimation). In some implementations, the label dataset (2) of a recommended bit loading profile can be a bit loading profile for a single CM. In some implementations, the label dataset (2) of a recommended bit loading profile can be uniform bit loading for clusters of CMs. In some implementations, the label dataset (2) of a recommended bit loading profile can be non-uniform bit loading. In some implementations, for the initial ML model training, the data collection (e.g., lab testing and simulation) can still capture all datasets for future use. In some implementations, for the initial ML model training, the ML engine can test typical classification-oriented neural network models (e.g. FC and CNN based models), since these models can solve data classification problems.

In some implementations, a chip (integrated circuit) can measure higher-order terms in the polynomial representation of an error vector such as x\hat{ }2, x\hat{ }3, x\hat{ }4 at input of an analog-to-digital convertor (ADC) in a radio frequency (RF) chain. In some implementations, a slicer error vector can measure higher-order terms such as x\hat{ }3 and x\hat{ }4, and in-phase and quadrature statistics separately for each constellation point (e.g., x\hat{ }2 for the complex error vector is already available for each constellation point). In some implementations, the system can use an additional input dataset including measured higher-order terms in the polynomial representation of an error vector such as x\hat{ }2, x\hat{ }3, x\hat{ }4. In some implementations, the ML engine can be trained using an additional input dataset that includes the amplifier's output power. This dataset may also contain a value representing the characterization of nonlinearity in the OFDM channel.

In some implementations, the ML engine can use an additional input dataset including the count of bit errors in a FEC decoder. This metric can show high promise for estimation of SNR margin for low-density parity-check (LDPC), much like the correctable codeword ratio performed for Single Carrier Quadrature Amplitude Modulation (SC-QAM; ITU-T J.83B) downstream link. In some implementations, the ML engine can use knowledge of operation of an LDPC decoder and QAM signaling to improve ML performance. In some implementations, the ML engine can provide, as an additional input dataset or an additional input vector, SER CDF and/or BER CDF, other statistics (e.g., AVG, STD), augmenting RxMER CDF and other statistics thereof.

In some implementations, an ML engine can train the first NN model, the second NN model, and/or the third NN model, resulting in a trained first NN model, a trained second NN model, and/or a trained third NN model. In some implementations, the ML engine can store the trained NN models (e.g., the trained first NN model, the trained second NN model, the trained third NN model) in an ML storage. In some implementations, the ML engine can perform inference by executing a trained NN model with (inference) input data to generate (inference) output data. In some implementations, data relating to performance of a cable modem can be collected by a data collector of the cable modem and sent to the ML engine. In response to receiving the data, the ML engine can execute a trained NN model with the data as input data, to generate output data (e.g., an estimated SNR margin or a recommended bit loading profile).

In some implementations, the ML engine can execute the trained first NN model by inputting (as inference input data) at least one of (1) statistical values of RxMER (e.g., CDF, AVG, STD, etc.), (2) statistical values of the number of iterations performed by a FEC decoder (e.g., CDF, AVG, STD, etc.), (3) a distribution of input power within one or more frequency segment across a channel of the cable modem, (4) an OFDM bit-loading profile. In some implementations, the ML engine can input to the first NN model, a tensor including all the inference input data (1)-(4) for the inference of the SNR margin NN. In some implementations, as a result of executing the trained first NN model, the ML engine can output (as inference output data) at least one of (1) SNR margin (equivalently referred to as “SNR threshold”) and/or (2) recommended bit loading (to improve communication performance of a cable modem).

In some implementations, the inference input data (1) of statistical values of RxMER can include an array of RxMER values (e.g., in float32 number format) including N percentage bins representing RxMER CDF. For example, the array of float32 numbers can have a size of 24 (e.g., float32 [0:23]) corresponding to respective percentage bins of 1, 2, 3, 4, 5, 10, 15, 20, 25, 30, 40, 50, 60, 70, 80, 90, 95, 98, 99, 99.9%, a minimum RxMER value, a maximum RxMER value, an AVG RxMER value, and a STD RxMER value. In some implementations, the RxMER CDF can represent a CDF of RxMER values for each bit-loading value, when non-uniform bit-loading is applied. In some implementations, the inference input data can include a CDF of SER values and/or a CDF of BER values, for each bit-loading.

In some implementations, the inference input data (2) of statistical values of the number of iterations can include an array of a plurality of percentage bins representing a CDF of FEC decoder iterations. For example, the array can include a plurality of elements representing percentage bins each corresponding to a percentage of codewords that require n (e.g., n=1,2,3, . . . , 12, 30) or more iterations. The array can also include an AVG iteration value.

In some implementations, the inference input data (3) of a distribution of input power of a cable modem can include an array of input power within 6 MHz frequency segments across DOCSIS downstream channels. For example, the array of float32 numbers can have a size of 32 (e.g., float32 [0:31]), corresponding to the distribution across one 192 MHz OFDM channel. In some implementations, the inference input data (4) of an OFDM bit-loading profile can include an integer value which corresponds to an index of an array of predefined bit-loading profiles.

In some implementations, the inference output data (1) of SNR margins can include an integer value corresponding to an index of an array of SNR margin bins. In some implementations, the inference output data (2) of recommended bit loading (e.g., a recommended bit loading profile) can include an integer value which corresponds to an index of an array of predefined bit-loading profiles.

In some implementations, the ML engine can execute the trained second NN model by inputting (as inference input data) at least one of (1) statistical values of RxMER (e.g., CDF, AVG, STD, etc.), (2) statistical values of the number of iterations performed by a FEC decoder (e.g., CDF, AVG, STD, etc.), (3) a distribution of input power within one or more frequency segment across a channel of the cable modem, and/or (4) an OFDM bit-loading profile. In some implementations, as a result of executing the trained second NN model, the ML engine can output (as inference output data) a rate of uncorrectable FEC errors. In some implementations, the inference output data of the rate of uncorrectable FEC errors can include an integer value corresponding to an index of an array of error rate bins for uncorrectable FEC errors. In some implementations, the inference output data of the rate of uncorrectable FEC errors can be used as an input dataset for training the first NN model (e.g., input dataset (5)).

In some implementations, the ML engine can execute the trained third NN model by inputting (as inference input data) at least one of (1) statistical values of RxMER (e.g., CDF, AVG, STD, etc.), (2) statistical values of the number of iterations performed by a FEC decoder (e.g., CDF, AVG, STD, etc.), (3) a distribution of input power within one or more frequency segment across a channel of the cable modem, and/or (4) an OFDM bit-loading profile. In some implementations, as a result of executing the trained third NN model, the ML engine can output (as inference output data) a rate of correctable FEC errors. In some implementations, the inference output data of the rate of correctable FEC errors can include an integer value corresponding to an index of an array of error rate bins for correctable FEC errors. In some implementations, the inference output data of the rate of correctable FEC errors can be used as an input dataset for training the first NN model (e.g., input dataset (6)).

Embodiments in the present disclosure have at least the following advantages and benefits. First, embodiments in the present disclosure can provide useful techniques for leveraging machine learning capability to augment analysis in estimating SNR margins. In some implementations, a system (e.g., a server 120, 540, 640, an ML engine 560, 622, 720, a CMTS 150, a cable modem 110-0, 520, 620, or a combination thereof) can rebuild a fixed table using artificial intelligence (AI) and/or machine learning (ML) which can be effective to characterize very complex relationship between input data and output data. Unlike conventional SNR margin estimation using a closed-form formula or a fixed table, an ML-based SNR margin estimation can be applicable to many different conditions (e.g., different channel conditions in different subcarriers). For example, the ML-based SNR margin estimation can effectively characterize a very complex relationship between such different conditions and SNR margins. Similarly, the ML-based SNR margin estimation can build a fixed table that can characterize a very complex relationship between such different conditions and SNR margins. In some implementations, the system can collect massive data (e.g., data relating to communication performance of cable modems) and use the massive data in estimating SNR margins.

Second, embodiments in the present disclosure can provide useful techniques for performing cable modem-based SNR margin estimation for inactive profiles with DOCSIS OFDM.

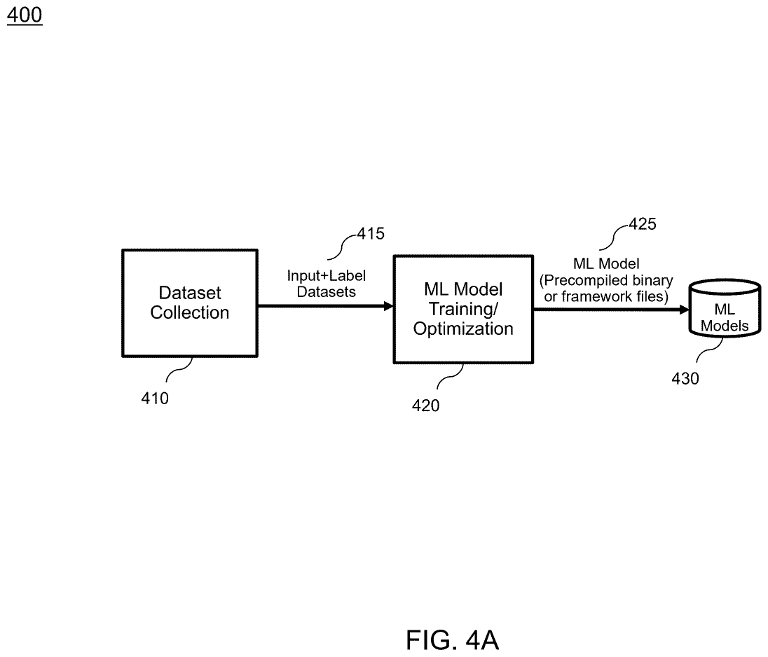

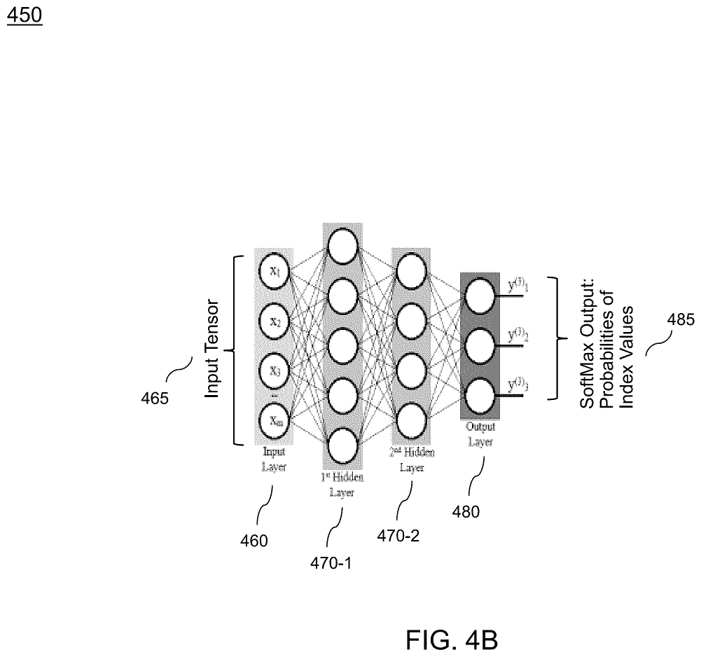

Referring to FIGS. 4-9, embodiments of systems and methods for the present solution to estimate or identify SNR margins are described and illustrated.

FIG. 4A and FIG. 4B are diagrams 400, 450 depicting an example process for training and/or optimizing one or more machine learning models, according to one or more embodiments. Referring to FIG. 4A, a system (see FIG. 1, for example) can collect 410 one or more datasets. The datasets 415 can include one or more input datasets (or test datasets) and/or one or more label datasets (e.g., datasets including ground truth). The datasets 415 can be collected in a laboratory testing environment with appropriate labeling, or generated by performing simulations (e.g., executing simulators). The datasets 415 can be collected from or by the system (e.g., a server 120, a CMTS 150, a cable modem 110-0, or a combination thereof) while the system is in operation. The system can create one or more machine learning models and/or select one or more machine learning models from among a plurality of machine learning models. The system can train and/or optimize one or more machine learning models 420 using the one or more input datasets 415 (or test datasets) and/or the one or more label datasets 415. The system can store one or more trained machine learning models 425 in a storage 430 (e.g., storage similar to the memory 2060). The one or more trained machine learning models 425 can be precompiled binary codes (e.g., codes executable by one or more processors 2010) or framework files (e.g., a configuration file based on which a trained machine learning model can be executed). The system can perform an iterative process of creating, training, and/or optimizing a machine learning model. The system can characterize performance and/or complexity of each machine learning model, and/or deploy a (trained) machine learning model per machine learning application deployment options.

Referring to FIG. 4B, the system can use a neural network model 450 (e.g., a fully connected (FC) neural network model or a CNN-based model) in estimating SNR margins. The neural network model 450 can include an input layer 460, a plurality of hidden layers (e.g., a first hidden layer 470-1, a second hidden layer 470-2, etc.), and an output layer 480. The system can configure the number of layers and/or the number of nodes in each layer in the neural network model 450. The system can use an input tensor 465 (e.g., a multi-dimensional array of numbers that can represent complex data relationships) to represent data input to the neural network model. For example, an input tensor can include m-dimensional data X₁, X₂, . . . , Xₘ. The neural network model 450 can receive the input tensor 465 as input to the input layer 460 and output data from the output layer. In estimating an SNR margin, the system can use an array of SNR margin bins to represent data output 485 from the neural network model. The data output 485 from the neural network model 450 can represent a probability distribution over multiple classes using a SoftMax function. For example, the data 485 output from the neural network model can include three SoftMax output values (probabilities) y⁽³⁾₁, y⁽³⁾₂, and y⁽³⁾₃ of index values of corresponding SNR margin bins (e.g., first, second and third SNR margin bins). The system can use an API for building and training neural network models (e.g., Keras/Python environment on computers). The system can output or store trained neural network models as files compatible with an open-source platform for machine learning (e.g., TensorFlow files).

FIG. 5 is a diagram depicting an example communication environment or system 500 with a cable modem 520, a server 540, and an machine learning (ML) engine 560 for estimating SNR margins, according to one or more embodiments. Referring to FIG. 5, the system 500 can deploy one or more machine learning (ML) models for SNR margin estimation in a remote server or a cloud system (e.g., cloud deployment option). The system 500 can include an ML storage 570, an ML engine and application 560, a server 540, and/or a cable modem 520. The ML storage 570 can have configurations similar to the memory 2060 in FIG. 2. The ML storage 570 can store one or more ML models (e.g., neural network models). The ML engine and application 560 can be implemented in hardware, software, firmware, or any combination thereof. The ML engine and application 560 can have configurations similar to configurations of the computing system 2000 in FIG. 2. The ML engine and application 560 can create, train and/or optimize one or more ML models. The ML engine and application 560 can execute one or more ML applications. For example, the one or more ML applications can include estimation of SNR margins and/or a performance dashboard (e.g., processing results or output of a (trained) ML model and rendering the processed results on the performance dashboard to show performance of one or more cable modems). The server 540 can have configurations similar to configurations of the server 120 in FIG. 1. The ML engine and application 560 can be implemented in the server 540. The server 540 can function as a portal or an entry point to various cable modem-related services (e.g., monitoring performance of cable modems).

The cable modem 520 can have configurations similar to the cable modem 110-0 in FIG. 1. The cable modem 520 can include a message broker 528, a data collector 526, and/or a cable modem (CM) physical layer (PHY) 522. Each of the message broker 528, the data collector 526, and the CM PHY 522 can be implemented in hardware, software, firmware, or any combination thereof. The CM PHY 522 can obtain or measure values relating to performance of the cable modem, such as RxMER values, a number of iterations performed in a FEC decoder, input power in a frequency segment across a channel (e.g., DOCSIS downstream channel), modulation configuration (e.g., OFDM bit-loading profile), an error rate of FEC correctable errors, and/or an error rate of FEC uncorrectable errors, etc. The data collector 526 can collect data 502 relating to performance of the cable modem 520, from the CM PHY 522 or other components, and send the collected data 502 to the message broker 528. The message broker 528 can manage communication with the server 540 and/or with the ML engine and application 560 via a computer network 550. For example, in response to receiving the collected data 502 from the data collector 526, the message broker 528 can send, communicate, or transmit the collected data 502 to the server 540 and/or the ML engine and application 560 so that the ML engine can use the collected data 502 to train and/or optimize the one or more ML models. The ML engine can use the collected data 502 for inference using a trained ML model. For example, the ML engine can provide the collected data 502 as input to the trained ML model so that the ML model can output an inference result (e.g., estimated SNR margin). In this configuration, the system 500 can utilize cloud ML processing assets (e.g., ML engine and application in a cloud system) thereby the ML models can run without significant impact on the rest of cable modem (CM) functions.

FIG. 6 is a diagram depicting another example communication environment or system 600 with a cable modem 620, a server 640, and an machine learning (ML) engine 622 for estimating SNR margins, according to one or more embodiments. Referring to FIG. 6, the system 600 can deploy one or more machine learning (ML) models for SNR margin estimation in the cable modem 620 (e.g., local deployment option). The system 600 can include an ML application 660, a server 640, and/or a cable modem 620. Each of the ML application 660, the server 640 and the cable modem 620 can have configurations similar to configurations of the computing system 2000 in FIG. 2. The ML application 660 can be implemented in the server 640. The server 640 can have configurations similar to configurations of the server 120 in FIG. 1. The server 640 can function as a portal or an entry point to various cable modem-related services (e.g., monitoring performance of cable modems). The ML application 660 can execute one or more ML applications. For example, the one or more ML applications can include estimation of SNR margins and/or a performance dashboard (e.g., processing results or output of a (trained) ML model and rendering the processed results on the performance dashboard to show performance of one or more cable modems).

The cable modem 620 can have configurations similar to the cable modem 110-0 in FIG. 1. The cable modem 620 can include an ML storage 626, an ML engine 622, an ML manager 624, a message broker 625, a data collector 623, and/or a CM PHY 621. Each of the ML engine 622, the ML manager 624, the message broker 625, the data collector 623, and the CM PHY 621 can be implemented in hardware, software, firmware, or any combination thereof. The ML storage 626 can have configurations similar to the memory 2060 in FIG. 2. The ML storage 626 can store one or more ML models (e.g., neural network models). The ML engine 622 can create, train and/or optimize one or more ML models. The message broker 625 can receive one or more ML models from the server 640 or the ML application 660, and store the received one or more ML models in the ML storage 626 (e.g., ML model provision 604).

The CM PHY 621 can obtain or measure values relating to performance of the cable modem, such as RxMER values, a number of iterations performed in a FEC decoder, input power in a frequency segment across a channel (e.g., DOCSIS downstream channel), modulation configuration (e.g., OFDM bit-loading profile), an error rate of FEC correctable errors, and/or an error rate of FEC uncorrectable errors, etc. The data collector 623 can collect data 602 relating to performance of the cable modem 620, from the CM PHY 621 or other components, and send the collected data 602 to the message broker 625 or to the ML manager 624.

The ML manager 624 can control the ML engine 622 to train and/or optimize one or more ML models using the collected data from the data collector 623. The ML manager 624 can control the ML engine 622 to use the collected data for inference using a trained ML model. For example, the ML engine 622 can provide the collected data as input to the trained ML model so that the ML model can output an inference result 604 (e.g., estimated SNR margin). In response to the ML model outputting the inference result 604, the ML manager can send the inference result 604 to the message broker 625.

The message broker 625 can manage communication with the server 640 and/or with the ML application 660 via a computer network 650. For example, in response to receiving the collected data 602 from the data collector 623 or receiving the inference result 604 from the ML manager 624, the message broker 625 can send, communicate, or transmit the collected data 602 or the inference result 604 to the server 640 and/or the ML application 660 so that the ML application 660 can process the collected data 602 or the inference result 604. For example, the ML application 660 can render the processed result on a performance dashboard to show performance of the cable modem. The system 600 can utilize local ML processing assets (e.g., on-chip ML processing of the cable modem 620 including the ML engine 622). The system 600 can utilize general computational power of the cable modem 620 (e.g., CPU or GPU of the cable modem 620) for ML processing if the ML model can run without significant impact on the rest of the CM function.

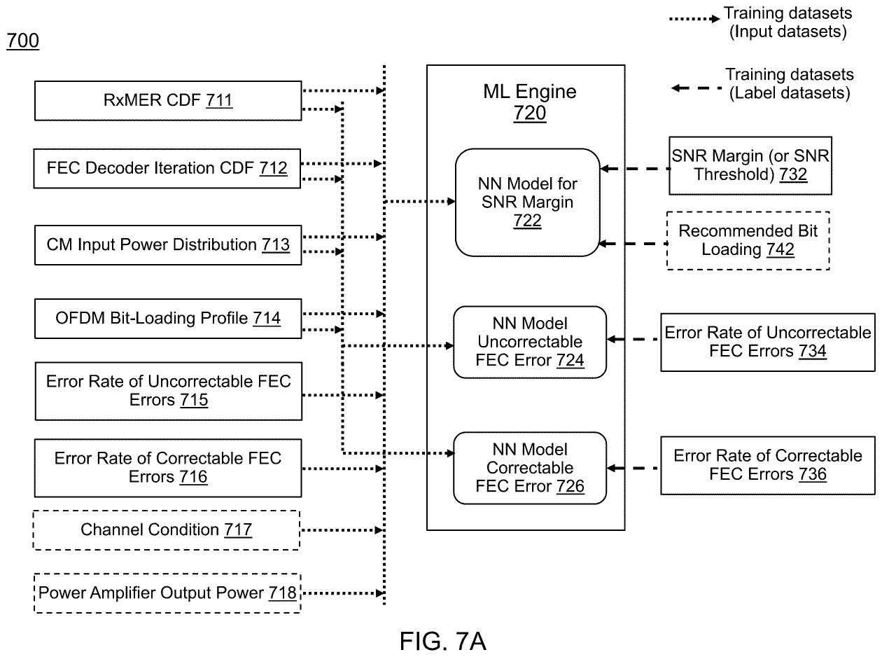

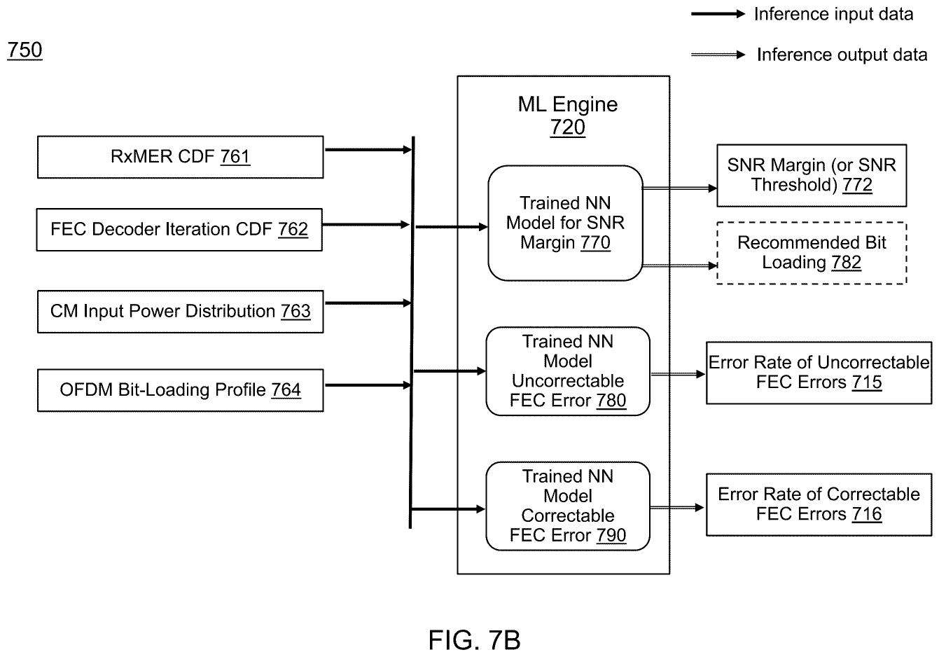

FIG. 7A and FIG. 7B are diagrams 700, 750 depicting an example machine learning (ML) engine 720, according to one or more embodiments. Referring to FIG. 7A, the ML engine 720 can train one or more neural network (NN) models including a first NN model 722 for inference of SNR margins of a particular cable modem, a second NN model 724 for inference of uncorrectable FEC errors of the cable modem, and/or a third NN model 726 for inference of correctable FEC errors of the cable modem. The ML engine 720 can train other types of ML models (other than NN models) for inference of SNR margins of a particular cable modem, uncorrectable FEC errors of the cable modem, and/or correctable FEC errors of the cable modem. The ML engine 720 can train the NN models (e.g., the first NN model 722, the second NN model 724, the third NN model 726) using respective training datasets, each training dataset including input datasets and/or label datasets (e.g., ground truth data). The training datasets (e.g., both input datasets and label datasets) can be collected in a laboratory testing environment with appropriate labeling, or generated by performing simulations (e.g., executing simulators). Input datasets can be collected using a data collector of a cable modem, and label datasets can be generated in a laboratory testing environment and/or by executing simulators. The ML engine 720 can train an NN model by iteratively (1) inputting one or more input datasets to the NN model to output data, (2) calculating a loss based on the output data of the NN model and the label data, and (3) updating the NN model based on the loss. During training, the output data being inferred can be provided to the NN model in addition to the datasets (e.g., the input dataset and the label dataset).

The ML engine 720 can train the first NN model 722 using (training) input datasets including at least one of (1) an input dataset 711 of statistical values of RxMER (e.g., cumulative distribution function (CDF), average (AVG), standard deviation (STD), etc.), (2) an input dataset 712 of statistical values of the number of iterations performed by a FEC decoder (e.g., CDF, AVG, STD, etc.), (3) an input dataset 713 of a distribution of input power within one or more frequency segment across a channel of the cable modem, (4) an input dataset 714 of an OFDM bit-loading profile, (5) an input dataset 715 of an error rate of uncorrectable FEC errors, (6) an input dataset 716 of an error rate of correctable FEC errors, (7) an input dataset 717 of a channel condition (e.g., SNR profile category), and/or (8) an input dataset 718 of output power of a power amplifier. The ML engine 720 can train the first NN model 720 using label datasets including at least one of (1) a label dataset 732 of SNR margin (equivalently referred to as “SNR threshold”) and/or (2) a label dataset 742 of recommended bit loading (to improve communication performance of a cable modem). The ML engine 720 can optimize the recommended bit loading for a given node (e.g., cable modem). In some implementations, the ML engine 720 can train the first NN model 722 using (training), among all input parameters 711-718, the input dataset 711 of statistical values of RxMER and the input dataset 714 of an OFDM bit-loading profile are mandatory, and other input parameters 712, 713, 715-718 are optional if available. For instance, for inactive bit-loading profiles, only the two inputs 711 and 714 are available for the model training and inference.

The input dataset 711 of statistical values of RxMER can include an array of RxMER values (e.g., in float32 number format which is a 32-bit a single-precision floating-point number format) including N percentage bins representing RxMER CDF. For example, the array of float32 numbers can have a size of 24 (e.g., float32 [0:23]) corresponding to respective percentage bins of 1, 2, 3, 4, 5, 10, 15, 20, 25, 30, 40, 50, 60, 70, 80, 90, 95, 98, 99, 99.9%, a minimum RxMER value, a maximum RxMER value, an AVG RxMER value, and a STD RxMER value. The RxMER CDF can represent a CDF of RxMER values for each bit-loading value, when non-uniform bit-loading is applied. The input datasets can include a CDF of symbol error rate (SER) values and/or a CDF of bit error rate (BER) values, for each bit-loading. The input datasets can include different RxMER CDF for each bit loading, for cases with non-uniform bit loading on subcarriers.

The input dataset 712 of statistical values of the number of iterations can include an array of a plurality of percentage bins representing a CDF of FEC decoder iterations. For example, the array can include a plurality of elements representing percentage bins each corresponding to a percentage of codewords that require n (e.g., n=1,2,3, . . . , 12, 30) or more iterations. The array can also include an AVG iteration value.

The input dataset 713 of a distribution of input power of a cable modem can include an array of input power within 6 MHz frequency segments across DOCSIS downstream channels. For example, the array of float32 numbers can have a size of 32 (e.g., float32 [0:31]), corresponding to the distribution across one 192 MHz OFDM channel. The input dataset 714 of an OFDM bit-loading profile can include an integer value which corresponds to an index of an array of predefined bit-loading profiles.

The input dataset 715 of an error rate of uncorrectable FEC errors can include an integer value corresponding to an index of an array of error rate bins. The input dataset 716 of an error rate of correctable FEC errors can include an integer value corresponding to the index of an array of error rate bins.

The input dataset 717 of a channel condition can represent an SNR profile category as a channel condition known during training. The input dataset 717 of a channel condition can include an integer value corresponding to one of channel conditions including (1) attenuation of high frequencies; (2) narrowband interference; (3) frequency-selective fading; (3) a level of SNR values (e.g., low, medium, high SNR); or (4) Intersymbol Interference (ISI) and Intercarrier Interference (ICI).

The input dataset 718 of output power of a power amplifier (e.g., power amplifier 112-0 in FIG. 1) can be optionally used in training the first NN model in order to incorporate the effect of a power amplifier with nonlinear artifacts, possibly digital predistortion (DPD), into the estimate of SNR margin (or SNR threshold). The input dataset 718 of output power of a power amplifier can include a value representing a characterization of the power amplifier (e.g., presence or absence of nonlinear distortion). The input dataset 718 of output power of a power amplifier can include one or more values representing output power of the power amplifier.

The label dataset 732 of SNR margins can include an integer value corresponding to an index of an array of SNR margin bins. The label dataset 742 of recommended bit loading (e.g., a recommended bit loading profile) can include an integer value which corresponds to an index of an array of predefined bit-loading profiles.

The ML engine 720 can train the second NN model 724 using (training) input datasets including at least one of (1) the input dataset 711 of statistical values of RxMER (e.g., CDF, AVG, STD, etc.), (2) the input dataset 712 of statistical values of the number of iterations performed by a FEC decoder (e.g., CDF, AVG, STD, etc.), (3) the input dataset 713 of a distribution of input power within one or more frequency segment across a channel of the cable modem, and/or (4) the input dataset 714 of an OFDM bit-loading profile. The ML engine 720 can train the second NN model 724 using a label dataset 734 of a rate of uncorrectable FEC errors. The label dataset 734 of a rate of uncorrectable FEC errors can include an integer value corresponding to an index of an array of error rate bins for uncorrectable FEC errors.

The ML engine 720 can train the third NN model 726 using (training) input datasets including at least one of (1) the input dataset 711 of statistical values of RxMER (e.g., CDF, AVG, STD, etc.), (2) the input dataset 712 of statistical values of the number of iterations performed by a FEC decoder (e.g., CDF, AVG, STD, etc.), (3) the input dataset 713 of a distribution of input power within one or more frequency segment across a channel of the cable modem, and/or (4) the input dataset 714 of an OFDM bit-loading profile. The ML engine 720 can train the third NN model 726 using a label dataset 736 of a rate of correctable FEC errors. The label dataset 736 of a rate of correctable FEC errors can include an integer value corresponding to an index of an array of error rate bins for correctable FEC errors.

The ML engine 720 can use the 3 independent NN models 722, 724, 726 for inference of SNR margin, uncorrectable FEC errors, and correctable FEC Errors, thereby providing simpler models, faster training, and modular solutions. The ML engine 720 can use joint NN models (instead of the 3 independent NN models). The ML engine 720 can use an additional label dataset (or an additional inference output from a trained NN model) raising a “red flag” for alert of a condition warranting attention. Input datasets for training a NN model can be a tensor. The ML engine 720 can use a tensor including all of the input datasets 711 to 716 for training the first NN model 722 (for inference of SNR margins).

For an initial ML model training, the ML engine 720 can fix the input dataset 714 of the OFDM bit-loading profile and the input dataset 717 of SNR profile category, and can limit the input datasets to the input dataset 711 of RxMER CDF, the input dataset 712 of FEC iteration CDF, and (optionally) the input dataset 713 of CM input power distribution. For the initial ML model training, the ML engine 720 can focus on training the first NN model 722 for SNR margin only (no FEC error estimation). The label dataset 742 of a recommended bit loading profile can be a bit loading profile for a single CM. The label dataset 742 of a recommended bit loading profile can be uniform bit loading for clusters of CMs. The label dataset 742 of a recommended bit loading profile can be non-uniform bit loading. For the initial ML model training, the data collection (e.g., lab testing and simulation) can still capture all datasets for future use. For the initial ML model training, the ML engine 720 can test typical classification-oriented neural network models (e.g. FC and CNN based models), since these models can solve data classification problems.

Referring to FIG. 7A and FIG. 7B, the ML engine 720 can train the first NN model 722, the second NN model 724, and/or the third NN model 726, resulting in a trained first NN model 770, a trained second NN model 780, and/or a trained third NN model 790. The ML engine 720 can store the trained NN models (e.g., the trained first NN model 770, the trained second NN model 780, the trained third NN model 790) in an ML storage (e.g., ML storage 570, 626). The ML engine 720 can perform inference by executing a trained NN model with (inference) input data to generate (inference) output data. Data relating to performance of a cable modem can be collected by a data collector of the cable modem (e.g., data collector 526, 623) and sent to the ML engine 720. In response to receiving the data, the ML engine 720 can execute a trained NN model with the data as input data, to generate output data (e.g., an estimated SNR margin or a recommended bit loading profile).

The ML engine 720 can execute the trained first NN model 770 by inputting (as inference input data) at least one of (1) inference input data 761 of statistical values of RxMER (e.g., CDF, AVG, STD, etc.), (2) inference input data 762 of statistical values of the number of iterations performed by a FEC decoder (e.g., CDF, AVG, STD, etc.), (3) inference input data 763 of a distribution of input power within one or more frequency segment across a channel of the cable modem, (4) inference input data 764 of an OFDM bit-loading profile. The ML engine 720 can input to the first NN model, a tensor including all the inference input data 761 to 764 for the inference of the SNR margin NN. As a result of executing the trained first NN model 770, the ML engine 720 can output (as inference output data) at least one of (1) inference output data 772 of SNR margin (equivalently referred to as “SNR threshold”) and/or (2) inference output data 782 of recommended bit loading (to improve communication performance of a cable modem).

The inference input data 761 of statistical values of RxMER can include an array of RxMER values (e.g., in float32 number format) including N percentage bins representing RxMER CDF. For example, the array of float32 numbers can have a size of 24 (e.g., float32 [0:23]) corresponding to respective percentage bins of 1, 2, 3, 4, 5, 10, 15, 20, 25, 30, 40, 50, 60, 70, 80, 90, 95, 98, 99, 99.9%, a minimum RxMER value, a maximum RxMER value, an AVG RxMER value, and a STD RxMER value. The RxMER CDF can represent a CDF of RxMER values for each bit-loading value, when non-uniform bit-loading is applied. The inference input data can include a CDF of SER values and/or a CDF of BER values, for each bit-loading.

The inference input data 762 of statistical values of the number of iterations can include an array of a plurality of percentage bins representing a CDF of FEC decoder iterations. For example, the array can include a plurality of elements representing percentage bins each corresponding to a percentage of codewords that require n (e.g., n=1,2,3, . . . , 12, 30) or more iterations. The array can also include an AVG iteration value.

The inference input data 763 of a distribution of input power of a cable modem can include an array of input power within 6 MHz frequency segments across DOCSIS downstream channels. For example, the array of float32 numbers can have a size of 32 (e.g., float32 [0:31]), corresponding to the distribution across one 192 MHz OFDM channel. The inference input data 764 of an OFDM bit-loading profile can include an integer value which corresponds to an index of an array of predefined bit-loading profiles.

The inference output data 772 of SNR margins can include an integer value corresponding to an index of an array of SNR margin bins. The inference output data 782 of recommended bit loading (e.g., a recommended bit loading profile) can include an integer value which corresponds to an index of an array of predefined bit-loading profiles.

The ML engine 720 can execute the trained second NN model 780 by inputting (as inference input data) at least one of (1) the inference input data 761 of statistical values of RxMER (e.g., CDF, AVG, STD, etc.), (2) the inference input data 762 of statistical values of the number of iterations performed by a FEC decoder (e.g., CDF, AVG, STD, etc.), (3) the inference input data 763 of a distribution of input power within one or more frequency segment across a channel of the cable modem, and/or (4) the inference input data 764 of an OFDM bit-loading profile. As a result of executing the trained second NN model 780, the ML engine 720 can output (as inference output data 715) a rate of uncorrectable FEC errors. The inference output data 715 of the rate of uncorrectable FEC errors can include an integer value corresponding to an index of an array of error rate bins for uncorrectable FEC errors. The inference output data 715 of the rate of uncorrectable FEC errors can be used as an input dataset for training the first NN model (e.g., the input dataset 715).

The ML engine 720 can execute the trained third NN model 790 by inputting (as inference input data) at least one of (1) the inference input data 761 of statistical values of RxMER (e.g., CDF, AVG, STD, etc.), (2) the inference input data 762 of statistical values of the number of iterations performed by a FEC decoder (e.g., CDF, AVG, STD, etc.), (3) the inference input data 763 of a distribution of input power within one or more frequency segment across a channel of the cable modem, and/or (4) the inference input data 764 of an OFDM bit-loading profile. As a result of executing the trained third NN model 790, the ML engine 720 can output inference output data 716 of a rate of correctable FEC errors. The inference output data 716 of the rate of correctable FEC errors can include an integer value corresponding to an index of an array of error rate bins for correctable FEC errors. The inference output data 716 of the rate of correctable FEC errors can be used as an input dataset for training the first NN model (e.g., the input dataset 716).

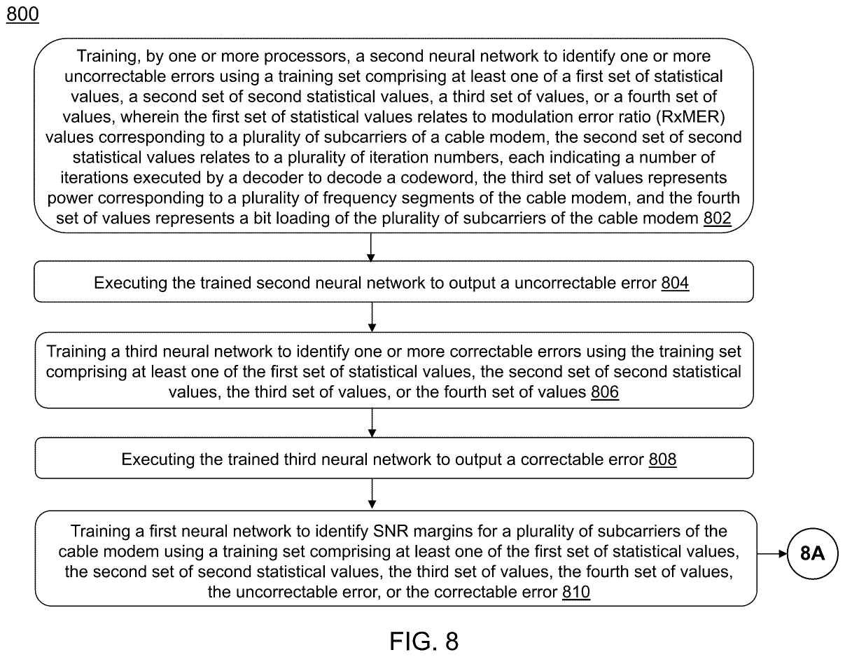

FIG. 8 is a flow diagram showing a process 800 for training one or more neural networks for identifying SNR margins of a cable modem, in accordance with an embodiment. In some implementations, the process 800 is performed by one or more processors of a cable modem (e.g. processor 2010 of cable modem 400-0, ML engine 622, 722), one or more processors of a remote ML engine (e.g., ML engine 560, 720), or one or more processors of a server (e.g., processor 2010 of server 120, 540, 640). In other embodiments, the process 800 is performed by other entities (e.g., a computing system other than the cable modem, the ML engine, the server). In some implementations, the process 800 includes more, fewer, or different steps than shown in FIG. 8.

At step 802, one or more processors (e.g., one or more processors of a cable modem, one or more processors of a remote ML engine, or one or more processors of a server) may train a second neural network (e.g., NN model 724 for uncorrectable FEC errors) to identify error rates of uncorrectable errors using a training set including at least one of a first set of statistical values (e.g., input dataset 711), a second set of second statistical values (e.g., input dataset 712), a third set of values (e.g., input dataset 713), or a fourth set of values (e.g., input dataset 714). The first set of statistical values (e.g., input dataset 711) may relate to receive modulation error ratio (RxMER) values corresponding to a plurality of subcarriers of a cable modem. The second set of second statistical values (e.g., input dataset 712) may relate to a plurality of iteration numbers, each indicating a number of iterations executed by a decoder to decode a codeword. The third set of values (e.g., input dataset 713) may represent power corresponding to a plurality of frequency segments of the cable modem. The fourth set of values (e.g., input dataset 714) may represent a bit loading of the plurality of subcarriers of the cable modem.

In some implementations, the first set of statistical values (e.g., input dataset 711) may include values representing at least one of a cumulative distribution function, a minimum, a maximum, an average or a standard deviation of RxMER values. In some implementations, the second set of second statistical values (e.g., input dataset 712) may include values representing at least one of a cumulative distribution function or an average of the plurality of iteration numbers. In some implementations, the third set of values (e.g., input dataset 713) may represent input power within each of the plurality of frequency segments across a downstream channel of the cable modem.

At step 804, the one or more processors may execute the trained second neural network (e.g., trained NN model 780) to output an error rate of uncorrectable errors (e.g., inference output data 715). In some implementations, the error rate of uncorrectable errors can be generated without executing the trained second neural network. For example, the error rate of uncorrectable errors can be generated separately (e.g., via experiments).

At step 806, the one or more processors may train a third neural network (e.g., NN model 726 for correctable FEC errors) to identify error rates of correctable errors using the training set including at least one of the first set of statistical values (e.g., input dataset 711), the second set of second statistical values (e.g., input dataset 712), the third set of values (e.g., input dataset 713), or the fourth set of values (e.g., input dataset 714).

At step 808, the one or more processors may execute the trained third neural network (e.g., trained NN model 790) to output an error rate of correctable errors (e.g., inference output data 716). In some implementations, the error rate of correctable errors can be generated without executing the trained third neural network. For example, the error rate of correctable errors can be generated separately (e.g., via experiments).

At step 810, the one or more processors may train a first neural network (e.g., NN model 722 for SNR margin) to identify SNR margins for a plurality of subcarriers of the cable modem using a training set including at least one of the first set of statistical values (e.g., input dataset 711), the second set of second statistical values (e.g., input dataset 712), the third set of values (e.g., input dataset 713), or the fourth set of values (e.g., input dataset 714), the error rate of uncorrectable errors (e.g., input dataset 715 which is the same as the inference output data 715), or the error rate of correctable errors (e.g., input dataset 716 which is the same as the inference output data 716).

In some implementations, the first neural network (e.g., NN model 722 for SNR margin) may be trained using the training set further including a fifth set of values (e.g., input dataset 718) representing output power of one or more power amplifiers (e.g., power amplifier 112-0) located between the cable modem (e.g., cable modem 110-0) and a cable modem termination system (CMTS) (e.g., CMTS 150).

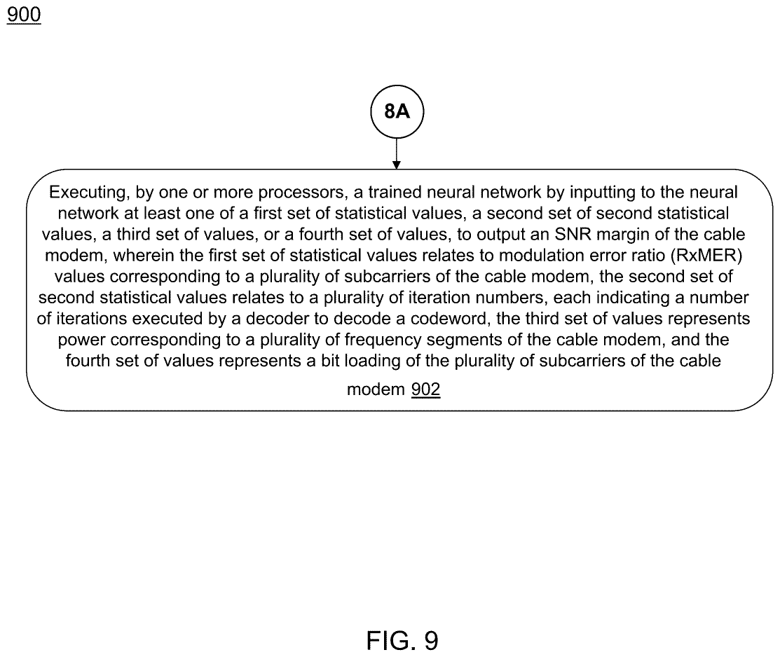

FIG. 9 is a flow diagram showing a process for identifying SNR margins of a cable modem using a trained neural network, in accordance with an embodiment. In some implementations, the process 900 is performed by one or more processors of a cable modem (e.g. processor 2010 of cable modem 400-0, ML engine 622, 722), one or more processors of a remote ML engine (e.g., ML engine 560, 720), or one or more processors of a server (e.g., processor 2010 of server 120, 540, 640). In other embodiments, the process 900 is performed by other entities (e.g., a computing system other than the cable modem, the ML engine, the server). In some implementations, the process 900 includes more, fewer, or different steps than shown in FIG. 9.

At step 902, one or more processors (e.g., one or more processors of a cable modem, one or more processors of a remote ML engine, or one or more processors of a server) may execute a trained neural network (e.g., trained NN model 770) by inputting to the trained neural network at least one of a first set of statistical values (e.g., inference input data 761), a second set of second statistical values (e.g., inference input data 762), a third set of values (e.g., inference input data 763), or a fourth set of values (e.g., inference input data 764), to output an SNR margin of the cable modem (e.g., inference output data 772). The first set of statistical values (e.g., inference input data 761) may relate to receive modulation error ratio (RxMER) values corresponding to a plurality of subcarriers of the cable modem. The second set of second statistical values (e.g., inference input data 762) may relate to a plurality of iteration numbers, each indicating a number of iterations executed by a decoder to decode a codeword. The third set of values (e.g., inference input data 763) may represent power corresponding to a plurality of frequency segments of the cable modem. The fourth set of values (e.g., inference input data 764) may represent a bit loading of the plurality of subcarriers of the cable modem.

In some implementations, in executing the trained neural network (e.g., trained NN model 770), the one or more processors may input to the neural network the first set of statistical values (e.g., inference input data 761), the second set of second statistical values (e.g., inference input data 762), the third set of values (e.g., inference input data 763), and the fourth set of values (e.g., inference input data 764). In some implementations, the first set of statistical values (e.g., inference input data 761) may include values representing at least one of a cumulative distribution function, a minimum, a maximum, an average or a standard deviation of RxMER values. In some implementations, the second set of second statistical values (e.g., inference input data 762) may include values representing at least one of a cumulative distribution function or an average of the plurality of iteration numbers. In some implementations, the third set of values (e.g., inference input data 763) may represent input power within each of the plurality of frequency segments across a downstream channel of the cable modem.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

It should be noted that certain passages of this disclosure can reference terms such as “first” and “second” in connection with subsets of transmit spatial streams, sounding frames, response, and devices, for purposes of identifying or differentiating one from another or from others. These terms are not intended to merely relate entities (e.g., a first device and a second device) temporally or according to a sequence, although in some cases, these entities can include such a relationship. Nor do these terms limit the number of possible entities (e.g., STAs, APs, beamformers and/or beamformees) that can operate within a system or environment. It should be understood that the systems described above can provide multiple ones of any or each of those components and these components can be provided on either a standalone machine or, In some implementations, on multiple machines in a distributed system. Further still, bit field positions can be changed and multibit words can be used. In addition, the systems and methods described above can be provided as one or more computer-readable programs or executable instructions embodied on or in one or more articles of manufacture, e.g., a floppy disk, a hard disk, a CD-ROM, a flash memory card, a PROM, a RAM, a ROM, or a magnetic tape. The programs can be implemented in any programming language, such as LISP, PERL, C, C++, C #, or in any byte code language such as JAVA. The software programs or executable instructions can be stored on or in one or more articles of manufacture as object code.

While the foregoing written description of the methods and systems enables one of ordinary skill to make and use embodiments thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A system for identifying signal-to-noise ratio (SNR) margins of a cable modem using a trained neural network, comprising:
one or more processors configured to:
execute the trained neural network by inputting to the neural network at least one of a first set of statistical values, a second set of second statistical values, a third set of values, or a fourth set of values, to output an SNR margin of the cable modem, wherein
the first set of statistical values relates to receive modulation error ratio (RxMER) values corresponding to a plurality of subcarriers of the cable modem,
the second set of second statistical values relates to a plurality of iteration numbers, each indicating a number of iterations executed by a decoder to decode a codeword,
the third set of values represents power corresponding to a plurality of frequency segments of the cable modem, and
the fourth set of values represents a bit loading of the plurality of subcarriers of the cable modem.

2. The system of claim 1, wherein in executing the trained neural network, the one or more processors are configured to:
input to the neural network the first set of statistical values, the second set of second statistical values, the third set of values, and the fourth set of values.

3. The system of claim 1, wherein the first set of statistical values comprises values representing at least one of a cumulative distribution function, a minimum, a maximum, an average or a standard deviation of RxMER values.

4. The system of claim 1, wherein the second set of second statistical values comprises values representing at least one of a cumulative distribution function or an average of the plurality of iteration numbers.

5. The system of claim 1, wherein the third set of values represents input power within each of the plurality of frequency segments across a downstream channel of the cable modem.

6. A method of training one or more neural networks for identifying signal-to-noise ratio (SNR) margins of a cable modem, comprising:
training, by one or more processors, a first neural network to identify SNR margins for a plurality of subcarriers of the cable modem using a training set comprising at least one of a first set of statistical values, a second set of second statistical values, a third set of values, or a fourth set of values, wherein
the first set of statistical values relates to receive modulation error ratio (RxMER) values corresponding to a plurality of subcarriers of a cable modem,
the second set of second statistical values relates to a plurality of iteration numbers, each indicating a number of iterations executed by a decoder to decode a codeword,
the third set of values represents power corresponding to a plurality of frequency segments of the cable modem, and
the fourth set of values represents a bit loading of the plurality of subcarriers of the cable modem.

7. The method of claim 6, wherein the training set comprises the first set of statistical values, the second set of second statistical values, the third set of values, and the fourth set of values.

8. The method of claim 6, wherein the first set of statistical values comprises values representing at least one of a cumulative distribution function, a minimum, a maximum, an average or a standard deviation of RxMER values.

9. The method of claim 6, wherein the second set of second statistical values comprises values representing at least one of a cumulative distribution function or an average of the plurality of iteration numbers.

10. The method of claim 6, wherein the third set of values represents input power within each of the plurality of frequency segments across a downstream channel of the cable modem.

11. The method of claim 6, further comprising:
training a second neural network to identify error rates of uncorrectable errors using the training set comprising at least one of the first set of statistical values, the second set of second statistical values, the third set of values, or the fourth set of values.

12. The method of claim 11, further comprising:
executing the trained second neural network to output an error rate of uncorrectable errors,
wherein the first neural network is trained using the training set further comprising the error rate of uncorrectable errors.

13. The method of claim 6, further comprising:
training a third neural network to identify error rates of correctable errors using the training set comprising at least one of the first set of statistical values, the second set of second statistical values, the third set of values, or the fourth set of values.

14. The method of claim 13, further comprising:
executing the trained third neural network to output an error rate of correctable errors,
wherein the first neural network is trained using the training set further comprising the error rate of correctable errors.

15. The method of claim 6, wherein
the first neural network is trained using the training set further comprising a fifth set of values representing output power of one or more power amplifiers located between the cable modem and a cable modem termination system (CMTS).

16. A method of identifying signal-to-noise ratio (SNR) margins of a cable modem using a trained neural network, comprising:
executing, by one or more processors, the trained neural network by inputting to the neural network at least one of a first set of statistical values, a second set of second statistical values, a third set of values, or a fourth set of values, to output an SNR margin of the cable modem, wherein
the first set of statistical values relates to receive modulation error ratio (RxMER) values corresponding to a plurality of subcarriers of the cable modem,
the second set of second statistical values relates to a plurality of iteration numbers, each indicating a number of iterations executed by a decoder to decode a codeword,
the third set of values represents power corresponding to a plurality of frequency segments of the cable modem, and
the fourth set of values represents a bit loading of the plurality of subcarriers of the cable modem.

17. The method of claim 16, wherein the trained neural network is executed by inputting to the neural network the first set of statistical values, the second set of second statistical values, the third set of values, and the fourth set of values.

18. The method of claim 16, wherein the first set of statistical values comprises values representing at least one of a cumulative distribution function, a minimum, a maximum, an average or a standard deviation of RxMER values.

19. The method of claim 16, wherein the second set of second statistical values comprises values representing at least one of a cumulative distribution function or an average of the plurality of iteration numbers.

20. The method of claim 16, wherein the third set of values represents input power within each of the plurality of frequency segments across a downstream channel of the cable modem.
